(19) United States
(12) Patent Application Publication
(10) Pub. No.: US 2012/0226609 A1
(43) Pub. Date: Sep. 6, 2012

(54) Remote Deposit Capture Method and Apparatus

(76) Inventors: Christopher F. EBBERT, Eden Prairie, MN (US); Suni BHUJLE, Eden Prairie, MN (US)

(21) Appl. No.: 13/399,527

(22) Filed: Feb. 17, 2012

Related U.S. Application Data
(60) Provisional application No. 61/444,417, filed on Feb. 18, 2011.

(51) Int. Cl. G06Q 40/02

(52) U.S. Cl. 705/42

(57) ABSTRACT

A remote deposit capture system is provided that includes the means for human evaluation of financial transactions.

### RELATED APPLICATIONS

The present application claims priority to and incorporates by reference U.S. Provisional Application No. 61/444,417 filed on Feb. 18, 2011.

### BACKGROUND

1. Field of the Invention

This invention relates to a remote deposit capture method and apparatus. In particular, the invention relates to a method and apparatus for remote deposit capture of a financial instrument that allows a human operator to review the instrument prior to completing processing of the instrument. Of course, a person of ordinary skill in the art will understand that the invention is not necessarily so limited.

2. Background of the Invention

Remote Deposit Capture (“RDC”) had been termed one of the most important developments the banking industry has seen in years. The Federal Reserve, nearly all of the top banks in the US, as well as other important financial institutions have either endorsed or launched RDC services.

In general terms, RDC is a service that allows a user to scan checks or other financial instruments and transmit the scanned images to a bank for posting and clearing. The basic requirements for an RDC service currently include a user computing device, an internet or network connection, a check scanner/digital camera, and a RDC service provider such as a bank or a third party provider working with the bank. Financial instruments, such as checks, are scanned to create a digital image. This digital image is then transmitted (usually over an encrypted internet connection) to a RDC processor and are then eventually cleared for deposit.

The advantages of RDC are many. For businesses the advantages include accelerated clearings, improved availability of banking services, enhanced cash flow, reduced costs, and consolidation of banking relationships. Similarly, RDC is beneficial to financial institutions by providing them with reduced transportation costs, new revenue streams and customers, and reduced processing and clearing costs. Consumers/users also benefit because they do not have to physically travel to a financial institution, and can conduct business with any institution and not just those located in nearby.

RDC does suffer from significant drawbacks. In particular, financial institutions can no longer evaluate a financial transaction in a face-to-face manner. The RDC transaction is conducted electronically under the control or one or more computer systems. As with any computer system, RDC systems can be fooled or manipulated into processing transactions that would not pass muster if the same transaction were processed by an actual human being. There is no substitute for human experience and judgment in matter such as these. While computers can be programmed to detect pre-defined sets of problems with financial instruments, they are not as proficient, lack the ability to learn, and lack the reasoning power of humans when it comes to these types of evaluations.

Accordingly, a need exists for a RDC system that overcomes the difficulties of the prior art by providing a means to apply human judgment to the process of evaluating financial transactions conducted through RDC systems.

### SUMMARY OF THE INVENTION

An object of the present invention is to provide a RDC system that substantially eliminates the problems of the prior art.

These and other objects of the present invention will become apparent to those skilled in the art upon reference to the following specification, drawings, and claims. To that end, the present invention comprises a remote deposit capture system that includes the means for human evaluation of financial transactions.

### BRIEF DESCRIPTION OF DRAWINGS

FIG. 1 is a flow chart of the present invention.

FIG. 2 is a data context chart of the present invention.

### DETAILED DESCRIPTION OF THE PREFERRED EMBODIMENTS

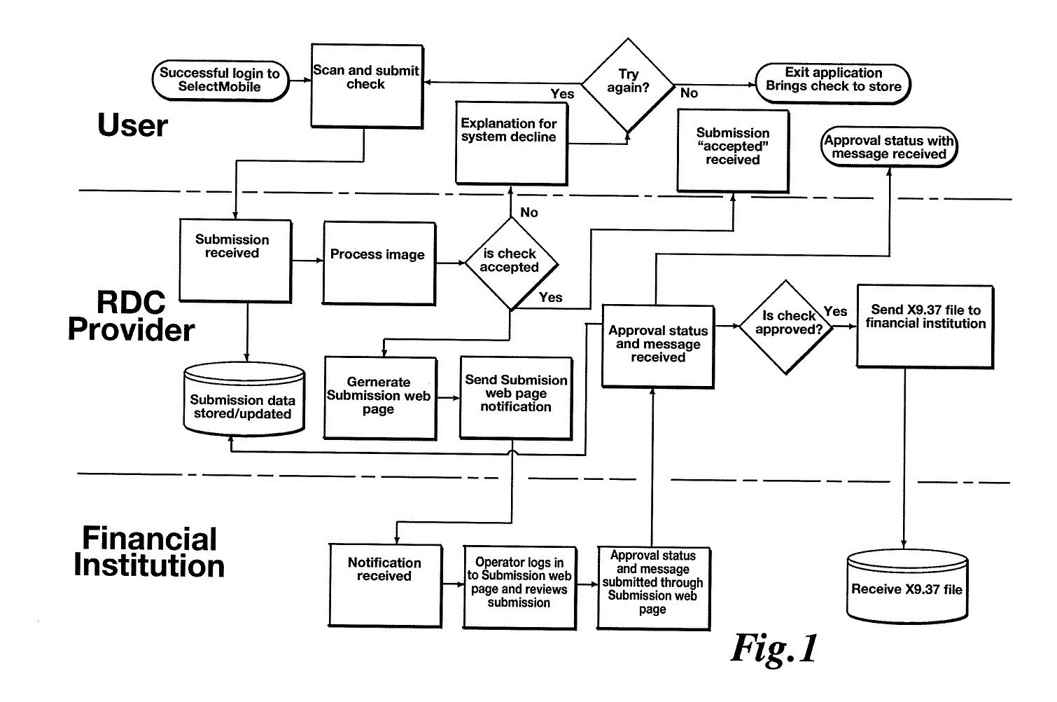

In the Figures, FIG. 1 shows a flowchart of the system of the present invention. The system operates between a User, a RDC Provider, and a Financial Institution. The process utilizes various hardware and software components, as described herein, which are distributed between the User, RDC Provider, and the Financial Institution.

In the first step of the process, the User having been provided with or given access to a software application denoted SelectMobile, initiates a session by logging on to the application. The application can be distributed to a computing device at the User's site, or the User can remotely access the application from a computing device via a network connection, such as the Internet. The User's computing device can be of any conventional type that can either directly run the application, or provide network access to the application. Such devices can include a desktop computer, a server, a mobile computing device such as a smart phone, handheld computer, and the like.

After initiating a session, whereby the User has provided sufficient indicia of authenticity to access an account, the User will capture on the computing device a financial instrument which the User desires the system to process. The capture can be accomplished with a scanning device, such as a flat bed scanner, a dedicated check scanner, or by utilizing a digital camera such as those commonly provided with handheld computing devices and/or smart phones or one interfaced with a desktop computer. The financial instrument in most cases would be a check which the User desires to deposit into a financial account with the Financial Institution, but could also be any other type of financial instrument processed by the Financial Institution such as a travelers check, money order, a payment coupon, and the like.

After the financial instrument has been captured, an electronic or digital image of the instrument is then submitted electronically to the RDC Provider for further processing. The RDC Provider receives the submission and begins processing. The RDC Provider utilizes combination of software and hardware components generally operating in the Provider's computer environment. The RDC Provider's network, servers, and software are utilized for this purpose.

The submission data is stored in the RDC Provider's database for data preservation and record keeping purposes.

The image of the financial instrument is then processed by the RDC Provider. In the case of a check, the processing would include utilizing character recognition software to capture the MICR (magnetic ink character recognition) information from the digital image of the financial instrument such as the account number of the account the check is written against, bank routing information, and check number. Additional information captured from the financial instrument includes information provided by CAR/LAR processing software. CAR/LAR (Courtesy Amount Recognition/Legal Amount Recognition) provides an automated method to capture and compare the written value and the numeric value lines on the financial instrument.

Next, a determination is made as to whether the check meets the predefined acceptance criteria used by the system. This evaluation would include determining if the information captured during the processing step is accurate, internally consistent, and valid. If the financial instrument is not acceptable, then the User is provided with an explanation as to the reason why the instrument was not accepted. The User is then given the choice to reprocess the instrument, or exit the application. The User always has the option of taking the financial instrument directly to a financial institution.

If the financial instrument is accepted, a submission received message is transmitted to the User so that the User is aware that at least initially the financial instrument has been successfully processed (but not fully accepted). As described below, additional processing and evaluation must occur before the financial instrument is finally accepted and deposited by the Financial Institution. The system cannot complete the transaction without the additional verification steps as described below.

After the submission received message is sent to the User, the system then generates a submission web page, which is then sent to the Financial Institutions computer processing system. This message can be sent via a computer network such as the Internet, through a local or intranet system, or it can be sent by a messaging system such as email or instant messaging.

At this point, processing is transferred to the Financial Institutions computer processing system. The notification sent from the RDC Processor is received by the Financial Institution. This notice would include all the information necessary for the Financial Institution to process and evaluate the financial instrument, including, the account number, routing number, check number, amount of the check, as well as the digital image of the front and back of the check/financial instrument. The notification may include information about multiple transactions for the User being processed at the same time, past history of User transactions, account status, or other information.

As stated above, the information can be passed to the Financial Institution in various manners. For example, the notification can be posted to a web page monitored by the Financial Institution, sent to an email account, and the like.

The information is then forwarded, or accessed, by an Operator at the Financial Institution. The Operator is preferably a human being qualified and trained to evaluate the financial instrument. The Operator has access to all of the information in the notification, including, the digital image of the financial instrument. While the system itself includes evaluations and tests to authenticate, evaluate, and verify the financial instrument, this is not the same as allowing a skilled professional human Operator to review the instrument. While computer systems can be programmed to find and detect irregularities, human skill, judgment, and reasoning is far superior at finding and detecting irregular, fraudulent, or suspect transactions.

Next, the Operator will submit an evaluation of the financial instrument, either approving or rejecting the instrument. If the instrument is rejected an explanation would be included indicating the reason for rejection. This information is submitted to the RDC Provider for processing.

If the transaction is approved by the Operator, the RDC Processor then sends a formal file to the Financial Institution that conforms to applicable standards for the transfer exchange of images of financial instruments between financial institutions, banks, and/or the Federal Reserve. In the most preferred embodiment, the information is sent in the X9.37 format. This file is then received by the Financial Institution and processed through its general ledger.

If the transaction is approved, the RDC Provider sends a message to the User indicating the approval status. If the Financial Institution Operator does not approve the transaction then a transaction denied message can be sent to the User through the RDC Provider.

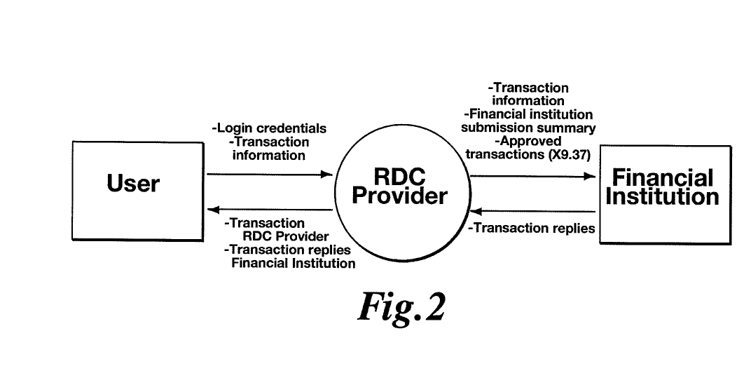

FIG. 2 is a system context chart showing generally the data exchange paths between the User, RDC Provider, and the Financial Institution. The sequence of processing steps is described above in reference to FIG. 1.

In this manner the system of the present invention substantially overcomes the limitations of the prior art. One of the principle advantages of RDC systems is that they allow Users to remotely process financial transactions. This can be extremely beneficial to merchants that can complete transactions at the point of service, regardless of the location. It is also helpful to the Financial Institution in that they can operate without limitation as to physical location and reduce associated overhead. One drawback of such an approach is that an entirely computer processed transaction is subject to fraud, mistake, and manipulation as computer systems are inherently limited with regard to the ability to avoid such problems.

The present invention solves this problem by providing a human Operator the ability to evaluate a transaction prior to approval and therefore apply qualified and skilled expertise to the transaction that is normally reserved for in-person transactions. This advantage is provided without limiting any of the advantages of RDC transactions or processing.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention. For example, the financial instrument processed by the present invention can comprise a check, money order, travelers check, and the like.

1. A remote deposit capture system providing a means for human evaluation of a financial transaction, the system comprising;
a computing device to capture an image of a financial instrument;
a computing device to recognize and interpret the image; and
depositing a sum of money set forth on the financial instrument in an account, after the image has been reviewed and approved.

2. The system of claim 1 where the review and approval is performed by human evaluation of the image.

3. The system of claim 1 where the recognition and interpretation of the image includes computer recognition of the written information on the image.

4. The system of claim 3 where the recognition and interpretation of the image includes computer recognition of encoded information.

5. The system of claim 4 further comprising the step of computerized evaluation of the written and encoded information.

6. The system of claim 1 where the image of the check is a photographic image.

7. The system of claim 1 where the image of the check is a scanned image.

8. The system of claim 2 where the evaluation includes information gained from the computer recognition and interpretation of the image.

9. The system of claim 1 wherein the computing device to capture an image of a financial instrument is operated by an end user.

10. The system of claim 1 wherein the computing device to recognize and interpret the image is operated by a remote deposit capture provider.

11. The system of claim 1 wherein the depositing a sum of money set forth on the financial instrument in an account is performed by a financial institution.

12. A remote deposit capture method providing a means for human evaluation of a financial transaction, the method comprising;
capturing an image of a financial instrument on a computing device;
recognizing and interpreting the image on a computing device;
reviewing and approving the image; and
depositing a sum of money set forth on the financial instrument in an account.
